(19) United States
(12) Patent Application Publication
(10) Pub. No.: US 2009/0249844 A1
(43) Pub. Date: Oct. 8, 2009

(54) Remotely Operated Lock With Cable Actuator

(76) Inventor: James Kinnucan, Roselle, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/099,589

(22) Filed: Apr. 8, 2008

(51) Int. Cl. E05B 65/20; B60J 5/00

(52) U.S. Cl. 70/237; 296/146.1

(57) ABSTRACT

A lock is provided for a vehicle. The lock system comprises a linear actuator, a deadbolt lock for the vehicle and a flexible Bowden cable connecting the linear actuator to the deadbolt lock, wherein the flexible Bowden cable is the sole connection between the linear actuator and deadbolt lock.

### FIELD OF THE INVENTION

The field of the invention relates to remotely operated locks and more particularly to locks for vehicles.

### BACKGROUND OF THE INVENTION

Remotely actuated locks are generally known. Such devices are typically used wherever the number of locks is too great for convenient activation or where the locks are located too far apart to be easily reached. Such locks are typically constructed by attaching a solenoid or some other type of actuator directly to the lock.

Automobiles are an example of where power locks are often used. However, the passenger door locks of automobiles and trucks are highly engineered mechanisms that must operate with great deal of predictability. For example, during a crash, the lock must not jam in such a way as to prevent an occupant from exiting the vehicle, especially in the event of fire. Alternatively, a door lock must still hold the passenger door closed with enough precision to help seal out weather and road noise.

In contrast to passenger doors on cars, the doors of other vehicles used for cargo or tools represent an entirely different set of problems. For example, a cargo van is typically provided with a pair of doors that provide access to a cargo space. A first of the pair of doors is usually provided with an internal release and locking bars that simultaneously engage a roof and floor of the cargo space. The second door is provided with a lock that engages the first door midway from the bottom to top.

Cargo vans are particularly subject to burglary both because of the value of the content of the cargo space and also because of the lock on the rear door is often easily defeated. In order to provide better security, at least some users have attached hasps across the rear doors. However, hasps are unsightly and offer the potential of trapping a user inside the cargo space in the event of a fire. Accordingly, a need exists for better methods of securing to vehicle doors.

### SUMMARY

A locking system is provided for a vehicle. The lock system comprises a linear actuator, a deadbolt lock for the vehicle and a flexible Bowden cable connecting the linear actuator to the deadbolt lock, wherein the flexible Bowden cable is the sole connection between the linear actuator and deadbolt lock.

In another aspect, the locking system includes a linear actuator, a deadbolt lock for the vehicle, a flexible cable having an outer sheath and an inner wire cable that connects the linear actuator to the deadbolt lock. A plunger is disposed within the deadbolt lock wherein the flexible cable extends through a closed end of the deadbolt lock and attaches within the plunger.

### BRIEF DESCRIPTION OF THE DRAWINGS

FIG. 1 depicts a prior art vehicular locking system;

FIG. 2 depicts an alternative vehicular locking system;

FIG. 3 depicts a vehicular locking system in accordance with an illustrated embodiment of the invention; and

FIG. 4 depicts a cut-away view of a deadbolt lock for the locking system of FIG. 3.

### DETAILED DESCRIPTION OF A PREFERRED EMBODIMENT

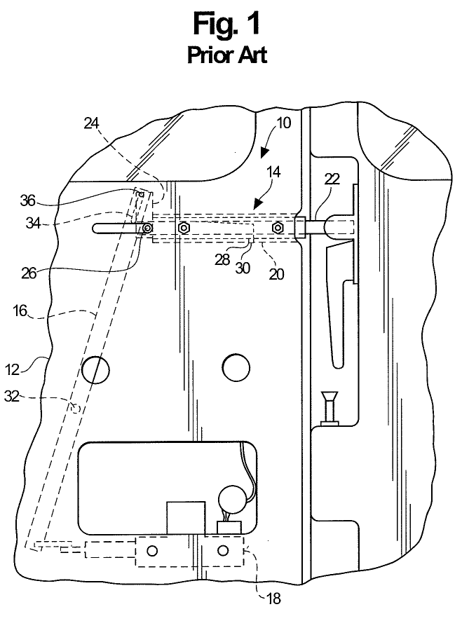

FIG. 1 shows a prior art lock system 10 shown in a context of use, mounted to a vehicle (e.g., a cargo van) 12. The lock system 10 includes a deadbolt 14, a lever arm 16 and an actuator 18. The deadbolt 14 includes a housing 20 and a locking plunger 22 that extends outward to lock the door of the vehicle. The locking plunger 22, in turn, is coupled to a pivot crank arm 24 that advances the locking plunger 22 into a locked position under control of the lever arm 16. In addition to advancing and retracting the plunger 22, the pivot crank arm 24 also pivots with respect to the plunger 22 about a shaft 26 to allow a hook 28 on the end of the pivot arm 24 to engage an opening 30 thereby locking the plunger 22 in an extended position.

The lever arm 16 is pivoted about a rivet 32 to advance and retract the plunger 22. A shaft 36 on the end of the pivot crank arm 24 engages through a slot 34 in the lever 16 to adapt the arcing movement of the end of the lever 16 to the linear movement of the plunger 22.

While the lock system of FIG. 1 is effective, it is also overly complex. In addition, the use of a lever 16 to connect the plunger 22 to the actuator 18 requires a great deal of valuable space within the door.

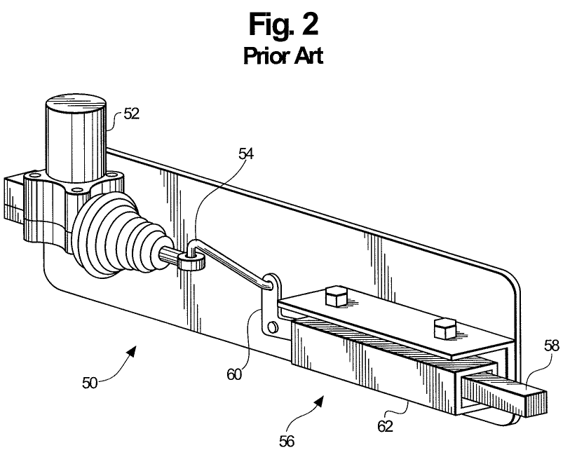

FIG. 2 is an example of another locking system 50 for use in a context similar to that of the system 10 of FIG. 1. The locking system 50 of FIG. 2 may use the same actuator 52 and deadbolt 56 as used in FIG. 1 but differs in that the lever 16 of FIG. 1 is replaced by a link 54 and the actuator 52 is mounted parallel with the axis of movement of the plunger 58.

In the case of the locking system 50, the actuator 52 may move the plunger 58 within the housing 62 between the locked and unlocked position through the pivot crank arm 60 and connecting link 54. In all other respects, the deadbolt 56 may operate substantially the same as the deadbolt 14 of FIG. 1.

While the locking system 50 is much simpler in design than the locking system 10, the locking system 50 also requires more space in the direction defined by the axis of movement of the plunger 58. Even with the connecting link 54 fabricated with the shortest possible length, the locking system 50 may not fit within the available space within some vehicles.

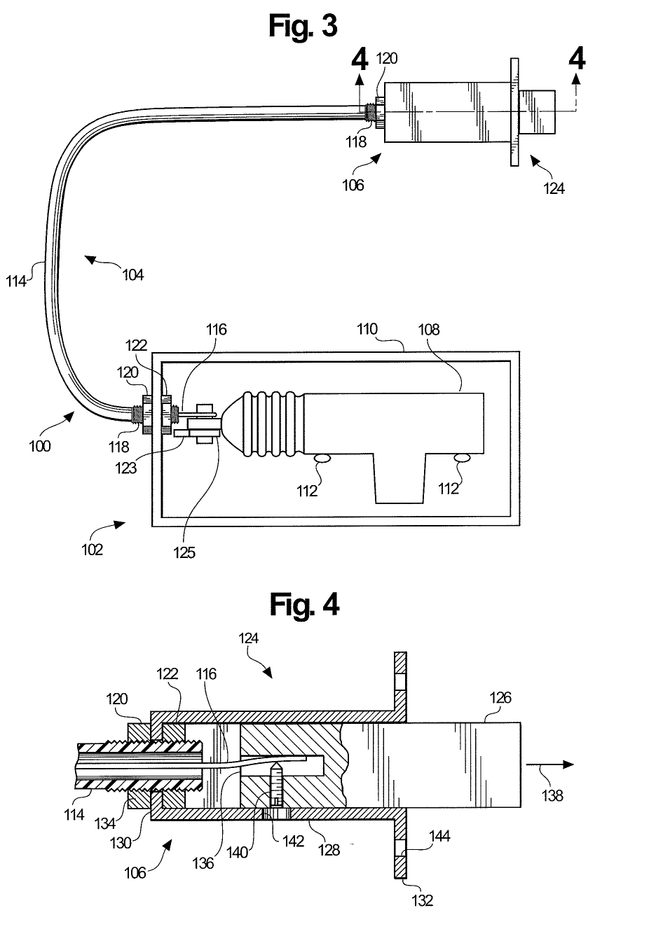

FIG. 3 depicts a locking system 100 shown generally in accordance with an illustrated embodiment of the invention. Included within the locking system may be a actuator assembly 102, a flexible connecting cable 104 and a deadbolt 106.

The actuator assembly 102 may include a linear actuator 108 disposed within an enclosure 110. The linear actuator 108 may be attached to the enclosure via a set of screws 112.

The linear actuator 108 may include a 12 volt DC motor. Application of 12 volts to the positive and negative terminals may activate the deadbolt 106 (i.e., extend the bolt). Reversing the voltage may retract the bolt.

The cable 104 is constructed to be flexible with a rubber or metal sheath 114 and an inner wire cable 116 that is movable with respect to the sheath 114 (e.g., a Bowden cable). The sheath 114 has threaded ends 118. First and second nuts 120, 122 secure the sheath 114 on a first end to the enclosure 110 of the actuator 102 and on a second end to an enclosure 124 of the deadbolt 106. In each case, the first nut is threaded onto the threaded end 118. The threaded end is then inserted through an aperture and the second nut 122 is added to complete the attachment of the sheath 114 to the enclosure 110.

FIG. 4 is a cut-away view of the deadbolt 106. As shown, the deadbolt 106 generally includes an enclosure 124 and a plunger or bolt 126. The enclosure 124 generally includes an elongated housing (e.g., a barrel, center portion, etc.) 128 with an end wall 130 that substantially closes off a rear of the enclosure 124 and a flange 132 on an open end of the center portion 128. The flange 132 includes a set of apertures 144 to secure the deadbolt 106 to a door or jam of a vehicle.

An aperture 134 through the end wall 130 allows the threaded end 118 of the sheath 114 to be inserted into the enclosure 124. A nut 120 on the outside and a nut 122 on the inside of the enclosure end wall 130 are threaded onto the threaded end 118 to secure the sheath 114 to the enclosure 124.

The plunger 126 is also elongated in the direction or axis of activation 138 and may be square, round or any other shape in cross-section (i.e., perpendicular to the direction of activation 138).

The plunger 126 is also provided with an aperture 136 that extends into the plunger 126 parallel to the direction of activation 138. The aperture 136 may be located at the geometric center of the cross-section.

The inner wire cable 116 extends into the aperture 136 of the plunger 126 and is secured to the plunger 126 by one or more set screws 140 that are threaded into the plunger 126 from the side. A corresponding set of apertures 142 are provided along the length of the center portion 128 to allow the inner wire cable 116 to be attached to the plunger 126 using a hex key inserted through the aperture 142 without removing the plunger 126 from the enclosure 124.

The actuator 102 may be activated in a forward direction to extend the plunger 126 and lock the vehicle (as shown in FIGS. 3 and 4) or activated in a reverse direction to retract the plunger 126, thereby unlocking the vehicle. A manual lever 125 may extend through a slot 123 in the enclosure 110 to manually unlock the vehicle.

The locking system 100 offers a number of advantages over the prior art. For example, the flexible cable 104 is the sole connection between the deadbolt 106 and actuator 102. This means that there is no need for a connection formed by a common mounting surface. The locking system 100 would function properly, in fact, if only the deadbolt 106 were mounted to the vehicle and the actuator 102 where left hanging from the cable 104. Since the cable 104 is flexible, the actuator 102 can be located in any geometry with respect to the deadbolt 106.

The configuration of the deadbolt 106 allows the deadbolt 106 to be used in extremely tight quarters where it is the most difficult to tamper with the deadbolt 106. In this regard, the attachment point of the cable 116 to the plunger 126 is inside the plunger 126, thereby allowing the deadbolt 106 to be much shorter than prior art deadbolts.

In addition, the compact nature of the deadbolt 106 and flexible cable 104 allows the locking system 100 to be installed in a location where a thief would least expect to find a deadbolt. In this regard, the locking direction of the plunger 126 may differ from the direction of activation of the actuator 102 by 180 degrees as shown in FIG. 3 or may be arranged at any other angle (e.g., 90 degrees, 45 degrees, etc.).

A specific embodiment of deadbolt locking for locking a vehicle has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A lock system for a vehicle comprising:
a linear actuator;
a deadbolt lock for the vehicle; and
a flexible Bowden cable connecting the linear actuator to the deadbolt lock, wherein the flexible Bowden cable is the sole connection between the linear actuator and deadbolt lock.

2. The lock as in claim 1 where the deadbolt lock further comprises a plunger disposed within an elongated housing having a first, open end from which the plunger extends axially along a principle axis of the elongated housing and a second, opposing closed end attached to the Bowden cable.

3. The lock as in claim 2 wherein the Bowden cable further comprises an outer sheath coupled between a housing of the linear actuator and the closed end of the elongated housing.

4. The lock as in claim 3 wherein the deadbolt further comprises an aperture centered on and extending into an end of the plunger parallel to the principle axis wherein the aperture is located adjacent the closed end of the elongated housing and receives an actuating wire extending through a center of the sheath of the Bowden cable.

5. The lock as in claim 4 further comprising a set screw that extends into a side of the plunger perpendicular to the principle axis, said screw engaging the actuating wire and securing the actuating wire to the bolt.

6. The lock as in claim 5 wherein the sheath further comprises a first threaded end that extends through an aperture in the closed end of the deadbolt housing and a complementary threaded nut engaging the threaded end on both sides of the closed end that rigidly secures the sheath to the closed end of the deadbolt housing.

7. The lock as in claim 6 wherein the housing further comprises an aperture through a side of the deadbolt housing, adjacent the closed end, that allows tightening of the set screw when the plunger is in a retracted position.

8. The lock as in claim 7 wherein the sheath further comprises a second threaded end on an end of the sheath opposite the first threaded end that extends through an aperture in a housing of the linear actuator and a complementary threaded nut engaging the threaded end on both sides of the linear aperture housing that rigidly secures the sheath to the closed end of the deadbolt housing.

9. The lock as in claim 8 wherein the linear actuator housing further comprises a slot extending through a side of the linear actuator housing and a lever extending through the slot, said lever attached to the linear actuator to allow manual activation and deactivation of the deadbolt lock.

10. A lock system for a vehicle comprising:
a linear actuator;
a deadbolt lock for the vehicle; and
a flexible cable connecting the linear actuator to the deadbolt lock, that allows the deadbolt lock to be offset in any direction from an output actuator of the linear actuator.

11. The lock as in claim 10 where the deadbolt lock further comprises a plunger disposed within an elongated housing having a first, open end from which the plunger extends axially along a principle axis of the elongated housing and a second, opposing closed end attached to the Bowden cable.

12. The lock as in claim 11 wherein the Bowden cable further comprises an outer sheath coupled between a housing of the linear actuator and the closed end of the elongated housing.

13. The lock as in claim 12 wherein the deadbolt further comprises an aperture centered on and extending into an end of the plunger parallel to the principle axis wherein the aperture is located adjacent the closed end of the elongated housing and receives an actuating wire extending through a center of the sheath of the flexible cable.

14. The lock as in claim 13 further comprising a set screw that extends into a side of the plunger perpendicular to the principle axis, said screw engaging the actuating wire and securing the actuating wire to the bolt.

15. The lock as in claim 14 wherein the sheath further comprises a first threaded end that extends through an aperture in the closed end of the deadbolt housing and a complementary threaded nut engaging the threaded end on both sides of the closed end that rigidly secures the sheath to the closed end of the deadbolt housing.

16. The lock as in claim 15 wherein the housing further comprises an aperture through a side of the deadbolt housing, adjacent the closed end, that allows tightening of the set screw when the plunger is in a retracted position.

17. The lock as in claim 16 wherein the sheath further comprises a second threaded end on an end of the sheath opposite the first threaded end that extends through an aperture in a housing of the linear actuator and a complementary threaded nut engaging the threaded end on both sides of the linear aperture housing that rigidly secures the sheath to the closed end of the deadbolt housing.

18. The lock as in claim 17 wherein the linear actuator housing further comprises a slot extending through a side of the linear actuator housing and a lever extending through the slot, said lever attached to the linear actuator to allow manual activation and deactivation of the deadbolt lock.

19. A lock system for a vehicle comprising:
a linear actuator;
a deadbolt lock for the vehicle;
a flexible cable having an outer sheath and an inner wire cable that connects the linear actuator to the deadbolt lock; and
a plunger disposed within the deadbolt lock wherein the flexible cable extends through a closed end of the deadbolt lock and attaches within the plunger.

20. The lock as in claim 19 wherein the flexible cable further comprises an outer sheath coupled between a housing of the linear actuator and the closed end of the elongated housing.

21. The lock as in claim 20 wherein the deadbolt further comprises an aperture centered on and extending into an end of the plunger parallel to the principle axis wherein the aperture is located adjacent the closed end of the elongated housing and receives an actuating wire extending through a center of the sheath of the Bowden cable.

22. The lock as in claim 21 further comprising a set screw that extends into a side of the plunger perpendicular to the principle axis, said screw engaging the actuating wire and securing the actuating wire to the bolt.
